(19) United States
(12) Patent Application Publication
(10) Pub. No.: US 2017/0090251 A1
(43) Pub. Date: Mar. 30, 2017

(54) LIQUID CRYSTAL DISPLAY DEVICE AND METHOD FOR PRODUCING LIQUID CRYSTAL DISPLAY DEVICE

(71) Applicant: Sharp Kabushiki Kaisha, Sakai City, Osaka (JP)

(72) Inventors: Masanobu MIZUSAKI, Sakai City (JP); Youhei NAKANISHI, Sakai City (JP); Toshihiro MATSUMOTO, Sakai City (JP)

(73) Assignee: Sharp Kabushiki Kaisha, Sakai City, Osaka (JP)

(21) Appl. No.: 15/126,305

(22) PCT Filed: Feb. 17, 2015
(86) PCT No.: PCT/JP2015/054220

§ 371 Date: Sep. 15, 2016

(30) Foreign Application Priority Data
Mar. 27, 2014 (JP) 2014-066581

(51) Int. Cl. G02F 1/1337; G02F 1/1339

(52) U.S. Cl. CPC G02F 1/133711; G02F 1/1339; G02F 2001/133742; G02F 2001/133738

(57) ABSTRACT

The present invention provides a liquid crystal display device less likely to cause peeling even with a narrow frame, and capable of achieving both a horizontal alignment mode and a vertical alignment mode without conventional alignment films; and a method for producing the liquid crystal display device. The liquid crystal display device includes a pair of substrates disposed to face each other; a liquid crystal layer and a sealing material disposed between the substrates; and an alignment control layer designed to control the alignment of liquid crystal molecules and disposed between each of the substrates and the liquid crystal layer, the substrates being in direct contact with the sealing material, the alignment control layers each being made of a polarized-light-absorbing compound, the polarized-light-absorbing compound containing in a molecule at least one of a phenylene group and a phenyl group and at least one of a carbonyl group and an azo group.

### TECHNICAL FIELD

The present invention relates to liquid crystal display devices and methods for producing a liquid crystal display device. More specifically, the present invention relates to a liquid crystal display device including no conventional alignment film, and a method for producing such a liquid crystal display device.

### BACKGROUND ART

Thin display devices such as liquid crystal display devices have spread rapidly, and are widely employed not only for televisions but also for devices such as electronic books, digital photo frames, industrial appliances (IAs), personal computers (PCs), tablet PCs, and smartphones. For these uses requiring various performances, various liquid crystal display modes have been developed.

The liquid crystal display modes include modes aligning liquid crystal molecules in a direction substantially parallel to the main surfaces of the substrates with no voltage applied (hereinafter, such modes are also referred to as horizontal alignment modes) such as the in-plane switching (IPS) mode and the fringe field switching (FFS) mode. The liquid crystal display modes also include modes aligning liquid crystal molecules in a direction substantially perpendicular to the main surfaces of the substrates with no voltage applied (hereinafter, such modes are also referred to as vertical alignment modes) such as the vertical alignment (VA) mode. In order to achieve such alignment control of liquid crystal molecules, Patent Literature 1, for example, discloses a liquid crystal display mode utilizing alignment films. Meanwhile, Patent Literatures 2 and 3 each disclose a liquid crystal display mode utilizing a technique in place of utilizing conventional alignment films.

### CITATION LIST

### Patent Literature

Patent Literature 1: US 2012/0021141 A1
Patent Literature 2: JP 5154945 B
Patent Literature 3: JP 2010-33093 A

### SUMMARY OF INVENTION

### Technical Problem

A common liquid crystal display device utilizing conventional alignment films is described below with reference to FIG. 8. FIG. 8 is a schematic cross-sectional view illustrating a conventional typical liquid crystal display device. As illustrated in FIG. 8, a liquid crystal display device 101 includes a lower substrate 102, an upper substrate 103 facing the lower substrate, alignment films 115c and 115d disposed between the substrates, a liquid crystal layer 105, and a sealing material 106. The alignment film 115c is disposed between the lower substrate 102 and the liquid crystal layer 105. The alignment film 115d is disposed between the upper substrate 103 and the liquid crystal layer 105. The alignment film 115c is present also between the lower substrate 102 and the sealing material 106. The alignment film 115d is also present between the upper substrate 103 and the sealing material 106. The lower substrate 102 and the upper substrate 103 each typically include a supporting substrate. Components required for the liquid crystal display mode, such as various electrodes, insulating films, and color filter layers, are suitably disposed on the supporting substrates. The conventional alignment films 115c and 115d are usually formed by polymerizing polymerizable monomers contained in the alignment film materials. Examples of those alignment films include polymer (e.g. polyimide) alignment films.

These conventional typical liquid crystal display devices, however, may cause peeling in the interface between an alignment film and a sealing material when being subjected to a load such as external power, temperature, and humidity, with the possibility of peeling increasing due to the trend of narrower frame designs. This is because the adhesion strength between an alignment film and a sealing material is originally low, and narrowing the width (thickness) of the sealing material along with the trend of the narrow frame design further decreases the adhesion area between the alignment film and the sealing material, resulting in even lower adhesion strength. A possible configuration to deal with this issue is one that does not employ an alignment film (e.g. alignment film 115c in FIG. 8) between a substrate (e.g. lower substrate 102 in FIG. 8) and a sealing material (e.g. sealing material 106 in FIG. 8) to avoid contact between the alignment film and the sealing material. However, such adjustment of the position of the alignment film has been impossible due to the film formation accuracy of alignment film formation (printing) devices.

In contrast, since a device utilizing an alternative technique in place of utilizing a conventional alignment film does not employ a conventional alignment film, the device can avoid the issue of peeling in the interface between an alignment film and a sealing material. In this case, however, the device cannot achieve both a horizontal alignment mode and a vertical alignment mode.

Patent Literature 1 discloses, in order to stabilize the alignment for a long period of time in the IPS mode, adding a polyfunctional polymerizable monomer to an alignment film material and, after formation of an alignment film, polymerizing the polymerizable monomer to form a polymer. The invention disclosed in Patent Literature 1, however, includes a step of forming an alignment film, which unfortunately forms a portion where an alignment film and a sealing material are in contact with each other due to the film formation accuracy of alignment film formation devices. The invention therefore could not solve the issue of peeling in the interface between an alignment film and a sealing material.

Patent Literature 2 discloses a method for producing a vertically aligned liquid crystal film on a plastic substrate without use of a conventional alignment film. The invention disclosed in Patent Literature 2, however, aims to achieve a vertical alignment mode, and does not disclose achievement of a horizontal alignment mode. Also, the invention disclosed in Patent Literature 2 is to be used for liquid crystal films, and includes liquid crystalline compounds consisting of monomers. Hence, the produced liquid crystal films cannot be driven by application of voltage, and thus cannot be used for liquid crystal display. For these reasons, Patent Literature 2 could not achieve both a horizontal alignment mode and a vertical alignment mode without conventional alignment films.

Patent Literature 3 does not employ conventional alignment films, and discloses formation of a vertical alignment polymer layer by polymerizing polymerizable monomers that contain a vertical alignment group and are added to the liquid crystal layer. The invention disclosed in Patent Literature 3, however, aims to achieve a vertical alignment mode, and does not disclose achievement of a horizontal alignment mode. The invention therefore could not achieve both a horizontal alignment mode and a vertical alignment mode without conventional alignment films.

The present invention was made in view of the above current state of the art, and aims to provide a liquid crystal display device that is less likely to cause peeling even with a narrow frame, and is capable of achieving both a horizontal alignment mode and a vertical alignment mode without conventional alignment films; and a method for producing the liquid crystal display device.

### Solution to Problem

The inventors of the present invention made various studies on liquid crystal display devices that are less likely to cause peeling even with a narrow frame, and are capable of achieving both a horizontal alignment mode and a vertical alignment mode without conventional alignment films, and methods for producing the liquid crystal display device. The inventors then focused on formation of an alignment control layer that controls the alignment of liquid crystal molecules by a method utilizing phase separation, from the liquid crystal layer, of a polarized-light-absorbing compound added to the liquid crystal layer. Such a configuration can eliminate a portion where an alignment film and a sealing material are in contact with each other, avoiding the issue of peeling in the interface between an alignment film and a sealing material. As a result of further intensive studies on the alignment control layer, the inventors have found that a polarized-light-absorbing compound containing in a molecule at least one of a phenylene group and a phenyl group and at least one of a carbonyl group and an azo group can achieve the following aims. That is, such a compound can satisfy two conditions that are necessary but difficult to achieve for a polarized-light-absorbing compound, namely easy addition (solution) in the liquid crystal layer and easy phase separation from the liquid crystal layer, and can achieve both of the two modes of a horizontal alignment mode and a vertical alignment mode which require greatly different pre-tilt angles. Thereby, the inventors have arrived at a solution for the above issue, completing the present invention.

That is, one aspect of the present invention may be a liquid crystal display device including: a pair of substrates disposed to face each other; a liquid crystal layer and a sealing material disposed between the substrates; and an alignment control layer that is designed to control the alignment of liquid crystal molecules and is disposed between each of the substrates and the liquid crystal layer, the substrates being in direct contact with the sealing material, the alignment control layers each being made of a polarized-light-absorbing compound, the polarized-light-absorbing compound containing in a molecule at least one of a phenylene group and a phenyl group and at least one of a carbonyl group and an azo group.

Another aspect of the present invention may be a method for producing a liquid crystal display device, including the steps of: (1) forming a liquid crystal layer containing a polarized-light-absorbing compound between substrates that are in pairs and are bonded to each other with a sealing material; (2) causing phase separation of the polarized-light-absorbing compound from the liquid crystal layer to form a layer between each of the substrates and the liquid crystal layer; and (3) irradiating the layers with polarized light with the temperature of the liquid crystal layer being set to T_{N-I} or higher to form alignment control layers designed to control the alignment of liquid crystal molecules, the T_{N-I} representing a phase transition temperature of a liquid crystal material contained in the liquid crystal layer between a nematic phase and an isotropic phase, the polarized-light-absorbing compound containing in a molecule at least one of a phenylene group and a phenyl group and at least one of a carbonyl group and an azo group.

### Advantageous Effects of Invention

The present invention can provide a liquid crystal display device that is less likely to cause peeling even with a narrow frame, and is capable of achieving both a horizontal alignment mode and a vertical alignment mode without conventional alignment films; and a method for producing the liquid crystal display device.

### BRIEF DESCRIPTION OF DRAWINGS

FIG. 1 is a schematic cross-sectional view of a liquid crystal display device of each of Examples 1 to 7.

FIG. 2 includes schematic cross-sectional views illustrating a production flow for liquid crystal display devices of Examples 1 to 4 (steps a to d).

FIG. 3 includes schematic cross-sectional views illustrating a production flow for liquid crystal display devices of Examples 5 and 6 (steps a to d).

FIG. 4 is a conceptual view for describing phase separation of a polarized-light-absorbing compound in Example 6.

FIG. 5 includes schematic cross-sectional views illustrating a production flow for a liquid crystal display device of Example 7 (steps a to d).

FIG. 6 is a schematic perspective view illustrating a first sample.

FIG. 7 is a schematic perspective view illustrating second and third samples.

FIG. 8 is a schematic cross-sectional view illustrating a conventional typical liquid crystal display device.

### DESCRIPTION OF EMBODIMENTS

The present invention will be described in more detail below based on examples with reference to the drawings. The present invention, however, is not limited to the examples. Also, the configurations in the examples may be appropriately combined or modified within the spirit of the present invention.

The polarized-light-absorbing compound herein refers to a compound containing a polarized-light-absorbing functional group in a molecule. Such a compound also has a feature of dissolving in liquid crystal and going through phase separation from the liquid crystal layer under specific conditions. Examples of the specific conditions include temperature change and adsorption on an inorganic compound. The polarized-light-absorbing functional group refers to a functional group that absorbs polarized light having a specific wavelength in the wavelength range of ultraviolet light and/or visible light when irradiated with such polarized light. A mode that aligns liquid crystal molecules in a direction substantially parallel to main surfaces of the substrates with no voltage applied is also referred to as a horizontal alignment mode. Here, being substantially parallel means that, for example, the pre-tilt angle of liquid crystal molecules is in the range of 0° to 5° from the main surfaces of the substrates. A mode that aligns liquid crystal molecules in a direction substantially perpendicular to main surfaces of the substrates with no voltage applied is also referred to as a vertical alignment mode. Being substantially perpendicular means that, for example, the pre-tilt angle of liquid crystal molecules is in the range of 85° to 90° from the main surfaces of the substrates. The room temperature refers to a temperature in the range of 15° C. to 30° C.

### Example 1

Example 1 is a case of using polyvinyl cinnamate as a polarized-light-absorbing compound to achieve a horizontal alignment mode.

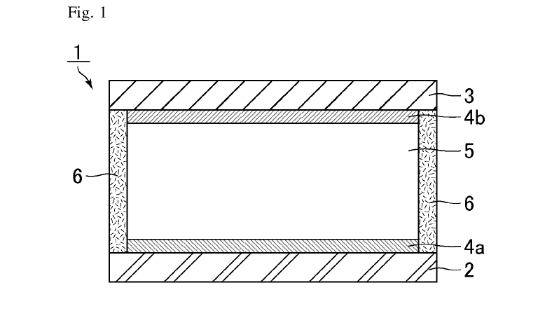

FIG. 1 is a schematic cross-sectional view of a liquid crystal display device of Example 1. As illustrated in FIG. 1, a liquid crystal display device 1 includes a lower substrate 2, an upper substrate 3 facing the lower substrate, alignment control layers 4a and 4b disposed between the substrates, a liquid crystal layer 5, and a sealing material 6. The alignment control layer 4a is disposed between the lower substrate 2 and the liquid crystal layer 5. The alignment control layer 4b is disposed between the upper substrate 3 and the liquid crystal layer 5. The sealing material 6 is in direct contact with the lower substrate 2 and the upper substrate 3 without the alignment control layer 4a or 4b in between. The liquid crystal display device 1 may further include a pair of polarizing plates which are disposed on the respective lower substrate 2 and upper substrate 3 on the sides opposite to the liquid crystal layer 5 sides.

The lower substrate 2 includes a glass substrate as the supporting substrate and components such as thin-film transistor elements suitably disposed on the glass substrate, and also includes pixel electrodes and a common electrode (not illustrated) in the same layer in a portion on an insulating film that covers the components such as thin-film transistor elements. Here, including pixel electrodes and a common electrode in the same layer means that the pixel electrodes and the common electrode are in contact with a common component (e.g., liquid crystal layer 5, insulating film) on the liquid crystal layer 5 side and/or the side opposite to the liquid crystal layer 5 side. The upper substrate 3 does not include an electrode, and includes a glass substrate as the supporting substrate and components such as color filter layers suitably arranged on the glass substrate. The upper substrate 3 also includes an overcoat layer covering the color filter layers. Neither the lower substrate 2 nor the upper substrate 3 includes conventional alignment films (e.g. alignment films 115c and 115d in FIG. 8). The sealing material 6 is in direct contact with the lower substrate 2, and is also in direct contact with the upper substrate 3.

The alignment control layers 4a and 4b are designed to control the alignment of liquid crystal molecules, and are formed through phase separation of polyvinyl cinnamate (polarized-light-absorbing compound), represented by the following chemical formula (1) and added to the liquid crystal layer 5, from the liquid crystal layer 5. The alignment control layers 4a and 4b can achieve a horizontal alignment mode.

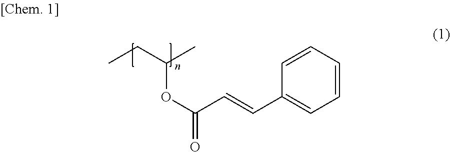

As described above, the liquid crystal display device of Example 1 is an IPS mode (horizontal alignment mode) liquid crystal display device. The liquid crystal display device of Example 1 does not include a portion where an alignment film and a sealing material are in contact with each other, differently from conventional liquid crystal display devices. This configuration can avoid the issue of peeling in the interface between an alignment film and a sealing material, thereby achieving a liquid crystal display device that is less likely to cause peeling even with a narrow frame.

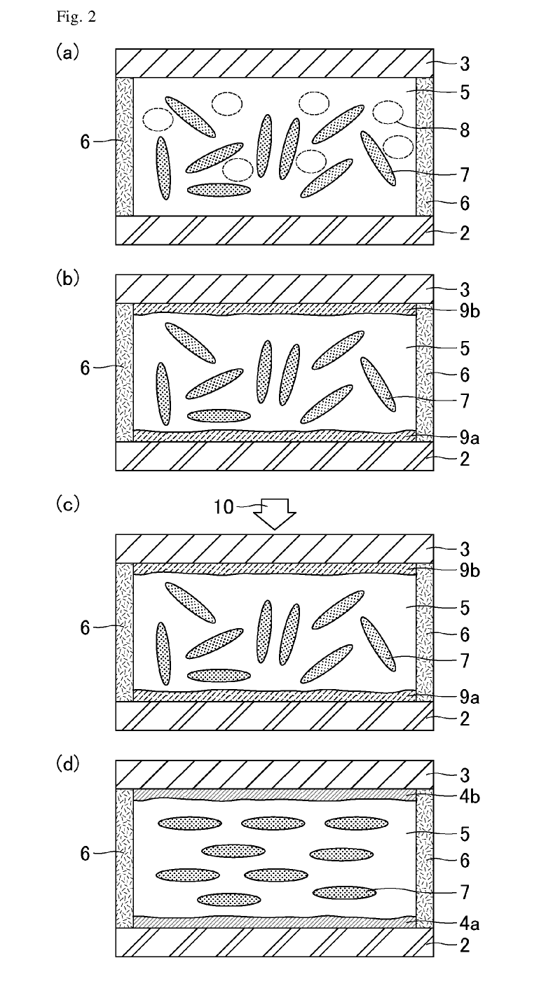

Next, the method for producing a liquid crystal display device of Example 1 is described with reference to FIG. 2. FIG. 2 includes schematic cross-sectional views illustrating a production flow for a liquid crystal display device of Example 1 (steps a to d).

### (a) Formation of Liquid Crystal Layer

First, polyvinyl cinnamate was added as a polarized-light-absorbing compound 8 to 5CB, a liquid crystal material having a positive anisotropy of dielectric constant, to 1 wt % of the whole mixture. The temperature was then raised to 50° C. to dissolve the polyvinyl cinnamate in the liquid crystal material. Here, T_{N-I} of 5CB, the liquid crystal material, is 35.5° C. Raising the temperature to 35.5° C. or higher dissolves polyvinyl cinnamate, while dropping the temperature to lower than 35.5° C. causes phase separation of polyvinyl cinnamate from the liquid crystal layer. The amount of polyvinyl cinnamate added is preferably in the range of 0.1 wt % to 10 wt % of the whole mixture with the liquid crystal material. If the amount of polyvinyl cinnamate added is less than 0.1 wt %, the very low concentration may not enable formation of the later-described alignment control layer in the entire interface between the liquid crystal layer and each substrate, failing to control the alignment of liquid crystal molecules sufficiently. If the amount of polyvinyl cinnamate added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes and a common electrode (not illustrated) in the same layer and the upper substrate 3 including no electrode as described above were prepared. Neither the lower substrate 2 nor the upper substrate 3 includes a conventional alignment film. The pixel electrodes and the common electrode were made of indium tin oxide (ITO).

Then, after the sealing material 6 was applied to the lower substrate 2, the liquid crystal material to which polyvinyl cinnamate was added as described above was dropwise added thereto at 50° C. The lower substrate 2 and the upper substrate 3 were then bonded to each other with the sealing material 6 in between as illustrated in the view (a) of FIG. 2, so that the liquid crystal layer 5 was formed. The sealing material 6 used was a sealing material (model: Photolec S) from Sekisui Chemical Co., Ltd. which is curable by both heat and ultraviolet light. The sealing material 6 may be a heat-curable one or ultraviolet-curable one. The liquid crystal material to which polyvinyl cinnamate was added may be injected between the bonded lower substrate 2 and upper substrate 3. The temperature for the step (a) may be any temperature equal to or higher than T_{N-I} of the liquid crystal material used. In the following description, the product produced in the step (a) is referred to as a liquid crystal cell for the sake of convenience. The same name is used in each of the other examples.

### (b) Phase Separation of Polarized-Light-Absorbing Compound

The temperature of the liquid crystal cell produced in the step (a) was dropped to 25° C. such that phase separation of polyvinyl cinnamate from the liquid crystal layer 5 occurred. The phase separation was achieved because, as described above, the phase separation of polyvinyl cinnamate from the liquid crystal layer 5 occurs when the temperature is lower than T_{N-I} of 5CB, the liquid crystal material. As a result, as illustrated in the view (b) of FIG. 2, a layer 9a was formed between the lower substrate 2 and the liquid crystal layer 5 while a layer 9b was formed between the upper substrate 3 and the liquid crystal layer 5. The temperature for the step (b) may be any temperature lower than T_{N-I} of the liquid crystal material used. The temperature of the liquid crystal cell is the temperature measured on the surface of the liquid crystal layer 5, and this condition is the same in the other examples.

### (c) Formation of Alignment Control Layer

As illustrated in the view (c) of FIG. 2, the temperature of the liquid crystal cell after the step (b) was raised to 36° C., and the liquid crystal cell was irradiated with linearly polarized ultraviolet light 10 from the normal direction thereof. The dose of the polarized ultraviolet light 10 was 3 J/cm² at a wavelength of 330 nm. As a result, cinnamate groups in the polyvinyl cinnamate constituting the layers 9a and 9b absorbed the linearly polarized ultraviolet light to cause a photoreaction such as a crosslinking reaction, whereby the alignment control layers 4a and 4b achieving a horizontal alignment mode as illustrated in the view (d) of FIG. 2 were formed. The temperature for the step (c) is preferably in the range of T_{N-I} to T_{N-I}+5° C. of the liquid crystal material used. Also, even when the temperature of the liquid crystal cell is raised to the range of T_{N-I} (35.5° C.) to T_{N-I}+5° C., the layers 9a and 9b will not dissolve in the liquid crystal layer 5 again to be in the state of the above step (a). This is because the crosslinking reaction proceeded in the layers 9a and 9b upon radiation of the polarized ultraviolet light 10, so that the layers do not dissolve in the liquid crystal layer 5.

### (d) Completion of Liquid Crystal Display Device

The temperature of the liquid crystal cell after the step (c) was dropped to the room temperature, and components such as polarizing plates and a backlight were suitably disposed. As a result, a horizontal electric field liquid crystal display device (liquid crystal display device of Example 1) as illustrated in the view (d) of FIG. 2 was completed which aligns liquid crystal molecules 7 in a direction substantially parallel to the main surfaces of the lower substrate 2 and the upper substrate 3 with no voltage applied. The width of the completed sealing material 6 was 0.5 mm.

Example 1 therefore enables production of an IPS mode (horizontal alignment mode) liquid crystal display device. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 1 was measured to be 0.5° or smaller from the main surfaces of the lower substrate 2 and the upper substrate 3. The pre-tilt angle was measured by the crystal rotation method with a device (model: OMS-AF2) from Chuo Precision Industrial Co., Ltd.

The transmitted light intensity of the liquid crystal display device produced in Example 1 was evaluated for the following cases (A) and (B). The transmitted light intensity was measured with an optical microscope system (model: ECLIPSE E600 POL) from Nikon Corporation.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device transmitted the light emitted from the backlight with no voltage applied, providing a light transmissive state.

The ratio of the transmitted light intensity in the above light transmissive state in the above case (B) to the transmitted light intensity in the black state in the above case (A) (transmitted light intensity in light transmissive state/transmitted light intensity in black state) was about 55. Each of the absorptive polarizing plates used in pairs was an absorptive polarizing plate (model: NPF-SEG1425DU) from Nitto Denko Corporation.

The above evaluation shows that the liquid crystal display device of Example 1 was in the IPS mode. Although the configuration for the IPS mode was achieved in Example 1, the configuration for the FFS mode which is also a horizontal alignment mode driven by a transverse electric field and the configuration for the electrically controlled birefringence (ECB) mode can also be achieved. For example, in the case of achieving the FFS mode, a substrate including pixel electrodes and a common electrode in different layers may be used as the lower substrate 2. In this case, an insulating film is disposed between the pixel electrodes and the common electrode. The common electrode may not be patterned.

### Example 2

Example 2 is a case of using low molecular weight trans-cinnamate as the polarized-light-absorbing compound to achieve a horizontal alignment mode.

A liquid crystal display device of Example 2 is the same as the liquid crystal display device of Example 1 except that the alignment control layers 4a and 4b were formed through phase separation of trans-cinnamate (polarized-light-absorbing compound), represented by the following chemical formula (2) and added to the liquid crystal layer 5, from the liquid crystal layer 5. The schematic cross-sectional view of the device is the same as illustrated in FIG. 1. In this case, the alignment control layers 4a and 4b can achieve a horizontal alignment mode.

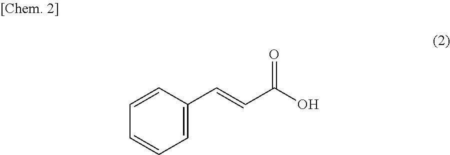 [SMILES: O=C(O)/C=C/c1ccccc1]

As described above, the liquid crystal display device of Example 2 is an IPS mode (horizontal alignment mode) liquid crystal display device. The liquid crystal display device of Example 2 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

Next, the method for producing a liquid crystal display device of Example 2 is described. The method for producing a liquid crystal display device of Example 2 is the same as the method for producing a liquid crystal display device of Example 1, except that trans-cinnamate was used in place of polyvinyl cinnamate as the polarized-light-absorbing compound 8. The schematic cross-sectional views illustrating the production flow are the same as illustrated in FIG. 2. Hence, the same points are not described here.

### (a) Formation of Liquid Crystal Layer

First, trans-cinnamate was added as the polarized-light-absorbing compound 8 to 5CB, a liquid crystal material having a positive anisotropy of dielectric constant, to 3 wt % of the whole mixture. The temperature was then raised to 50° C. to dissolve the trans-cinnamate completely in the liquid crystal material. The amount of trans-cinnamate added is preferably in the range of 0.1 wt % to 10 wt % of the whole mixture with the liquid crystal material. If the amount of trans-cinnamate added is less than 0.1 wt %, the very low concentration may not enable formation of the later-described alignment control layer in the entire interface between the liquid crystal layer and each substrate, failing to control the alignment of liquid crystal molecules sufficiently. If the amount of trans-cinnamate added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes and a common electrode in the same layer and the upper substrate 3 including no electrode were prepared. Neither the lower substrate 2 nor the upper substrate 3 includes a conventional alignment film.

Then, after the sealing material 6 was applied to the lower substrate 2, the liquid crystal material to which trans-cinnamate was added as described above was dropwise added thereto at 50° C. The lower substrate 2 and the upper substrate 3 were then bonded to each other with the sealing material 6 in between as illustrated in the view (a) of FIG. 2, so that the liquid crystal layer 5 was formed.

### (b) Phase Separation of Polarized-Light-Absorbing Compound

The temperature of the liquid crystal cell produced in the step (a) was dropped to 25° C. such that the interaction (e.g. hydrogen bond) between the substrate surface and the carboxyl groups in trans-cinnamate was stabilized and thereby phase separation of trans-cinnamate from the liquid crystal layer 5 occurred. As a result, as illustrated in the view (b) of FIG. 2, the layer 9a was formed between the lower substrate 2 and the liquid crystal layer 5 while the layer 9b was formed between the upper substrate 3 and the liquid crystal layer 5.

### (c) Formation of Alignment Control Layer

As illustrated in the view (c) of FIG. 2, the temperature of the liquid crystal cell after the step (b) was raised to 36° C., and the liquid crystal cell was irradiated with the linearly polarized ultraviolet light 10 from the normal direction thereof. The dose of the polarized ultraviolet light 10 was 4 J/cm² at a wavelength of 330 nm. As a result, cinnamate groups in the trans-cinnamate constituting the layers 9a and 9b absorbed the linearly polarized ultraviolet light to cause a photoreaction such as a crosslinking reaction, whereby the alignment control layers 4a and 4b achieving a horizontal alignment mode as illustrated in the view (d) of FIG. 2 were formed.

### (d) Completion of Liquid Crystal Display Device

The temperature of the liquid crystal cell after the step (c) was dropped to the room temperature, and components such as polarizing plates and a backlight were suitably disposed. As a result, a horizontal electric field liquid crystal display device (liquid crystal display device of Example 2) as illustrated in the view (d) of FIG. 2 was completed which aligns the liquid crystal molecules 7 in a direction substantially parallel to the main surfaces of the lower substrate 2 and the upper substrate 3 with no voltage applied. The width of the completed sealing material 6 was 0.5 mm.

Example 2 therefore enables production of an IPS mode (horizontal alignment mode) liquid crystal display device even in the case of using a low molecular weight polarized-light-absorbing compound containing cinnamate groups. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 2 was measured to be 0.5° or smaller from the main surfaces of the lower substrate 2 and the upper substrate 3. The pre-tilt angle was measured by the same method as in Example 1.

The transmitted light intensity of the liquid crystal display device produced in Example 2 was evaluated for the following cases (A) and (B). The transmitted light intensity was measured by the same method as in Example 1.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device transmitted the light emitted from the backlight with no voltage applied, providing a light transmissive state.

The ratio of the transmitted light intensity in the above light transmissive state in the above case (B) to the transmitted light intensity in the black state in the above case (A) (transmitted light intensity in light transmissive state/transmitted light intensity in black state) was about 55.

The above evaluation shows that the liquid crystal display device of Example 2 was in the IPS mode.

### Example 3

Example 3 is a case of using low molecular weight 4-hydroxychalcone as the polarized-light-absorbing compound to achieve a horizontal alignment mode.

A liquid crystal display device of Example 3 is the same as the liquid crystal display device of Example 1 except that the alignment control layers 4a and 4b were formed through phase separation of 4-hydroxychalcone (polarized-light-absorbing compound), represented by the following chemical formula (3) and added to the liquid crystal layer 5, from the liquid crystal layer 5. The schematic cross-sectional view of the device is the same as illustrated in FIG. 1. In this case, the alignment control layers 4a and 4b can achieve a horizontal alignment mode.

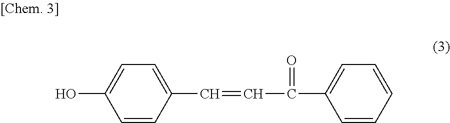 [SMILES: O=C(C=Cc1ccc(O)cc1)c1ccccc1]

As described above, the liquid crystal display device of Example 3 is an IPS mode (horizontal alignment mode) liquid crystal display device. The liquid crystal display device of Example 3 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

Next, the method for producing a liquid crystal display device of Example 3 is described. The method for producing a liquid crystal display device of Example 3 is the same as the method for producing a liquid crystal display device of Example 1, except that 4-hydroxychalcone was used in place of polyvinyl cinnamate as the polarized-light-absorbing compound 8. The schematic cross-sectional views illustrating the production flow are the same as illustrated in FIG. 2. Hence, the same points are not described here.

### (a) Formation of Liquid Crystal Layer

First, 4-hydroxychalcone was added as the polarized-light-absorbing compound 8 to 5CB, a liquid crystal material having a positive anisotropy of dielectric constant, to 3 wt % of the whole mixture. The temperature was then raised to 50° C. to dissolve the 4-hydroxychalcone completely in the liquid crystal material. The amount of 4-hydroxychalcone added is preferably in the range of 0.1 wt % to 10 wt % of the whole mixture with the liquid crystal material. If the amount of 4-hydroxychalcone added is less than 0.1 wt %, the very low concentration may not enable formation of the later-described alignment control layer in the entire interface between the liquid crystal layer and each substrate, failing to control the alignment of liquid crystal molecules sufficiently. If the amount of 4-hydroxychalcone added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes and a common electrode in the same layer and the upper substrate 3 including no electrode were prepared. Neither the lower substrate 2 nor the upper substrate 3 includes a conventional alignment film.

Then, after the sealing material 6 was applied to the lower substrate 2, the liquid crystal material to which 4-hydroxychalcone was added as described above was dropwise added thereto at 50° C. The lower substrate 2 and the upper substrate 3 were then bonded to each other with the sealing material 6 in between as illustrated in the view (a) of FIG. 2, so that the liquid crystal layer 5 was formed.

### (b) Phase Separation of Polarized-Light-Absorbing Compound

The temperature of the liquid crystal cell produced in the step (a) was dropped to 25° C. such that the interaction (e.g. hydrogen bond) between the substrate surface and the hydroxyl groups in 4-hydroxychalcone was stabilized and thereby phase separation of 4-hydroxychalcone from the liquid crystal layer 5 occurred. As a result, as illustrated in the view (b) of FIG. 2, the layer 9a was formed between the lower substrate 2 and the liquid crystal layer 5 while the layer 9b was formed between the upper substrate 3 and the liquid crystal layer 5.

### (c) Formation of Alignment Control Layer

As illustrated in the view (c) of FIG. 2, the temperature of the liquid crystal cell after the step (b) was raised to 36° C., and the liquid crystal cell was irradiated with the linearly polarized ultraviolet light 10 from the normal direction thereof. The dose of the polarized ultraviolet light 10 was 3 J/cm² at a wavelength of 365 nm. As a result, chalcone groups in the 4-hydroxychalcone constituting the layers 9a and 9b absorbed the linearly polarized ultraviolet light to cause a photoreaction such as a crosslinking reaction, whereby the alignment control layers 4a and 4b achieving a horizontal alignment mode as illustrated in the view (d) of FIG. 2 were formed.

### (d) Completion of Liquid Crystal Display Device

The temperature of the liquid crystal cell after the step (c) was dropped to the room temperature, and components such as polarizing plates and a backlight were suitably disposed. As a result, a horizontal electric field liquid crystal display device (liquid crystal display device of Example 3) as illustrated in the view (d) of FIG. 2 was completed which aligns the liquid crystal molecules 7 in a direction substantially parallel to the main surfaces of the lower substrate 2 and the upper substrate 3 with no voltage applied. The width of the completed sealing material 6 was 0.5 mm.

Example 3 therefore enables production of an IPS mode (horizontal alignment mode) liquid crystal display device even in the case of using a low molecular weight polarized-light-absorbing compound containing chalcone groups. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 8 in the liquid crystal display device produced in Example 3 was measured to be 0.5° or smaller from the main surfaces of the lower substrate 2 and the upper substrate 3. The pre-tilt angle was measured by the same method as in Example 1.

The transmitted light intensity of the liquid crystal display device produced in Example 3 was evaluated for the following cases (A) and (B). The transmitted light intensity was measured by the same method as in Example 1.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device transmitted the light emitted from the backlight with no voltage applied, providing a light transmissive state.

The ratio of the transmitted light intensity in the above light transmissive state in the above case (B) to the transmitted light intensity in the black state in the above case (A) (transmitted light intensity in light transmissive state/transmitted light intensity in black state) was about 55.

The above evaluation shows that the liquid crystal display device of Example 3 was in the IPS mode.

### Example 4

Example 4 is a case of using low molecular weight 4′-hydroxychalcone as the polarized-light-absorbing compound to achieve a horizontal alignment mode.

A liquid crystal display device of Example 4 is the same as the liquid crystal display device of Example 1 except that the alignment control layers 4a and 4b were formed through phase separation of 4′-hydroxychalcone (polarized-light-absorbing compound), represented by the following chemical formula (4) and added to the liquid crystal layer 5, from the liquid crystal layer 5. The schematic cross-sectional view of the device is the same as illustrated in FIG. 1. In this case, the alignment control layers 4a and 4b can achieve a horizontal alignment mode.

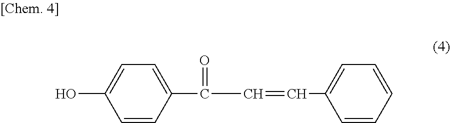 [SMILES: O=C(C=Cc1ccccc1)c1ccc(O)cc1]

As described above, the liquid crystal display device of Example 4 is an IPS mode (horizontal alignment mode) liquid crystal display device. The liquid crystal display device of Example 4 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

Next, the method for producing a liquid crystal display device of Example 4 is described. The method for producing a liquid crystal display device of Example 4 is the same as the method for producing a liquid crystal display device of Example 1, except that 4′-hydroxychalcone was used in place of polyvinyl cinnamate as the polarized-light-absorbing compound 8. The schematic cross-sectional views illustrating the production flow are the same as illustrated in FIG. 2. Hence, the same points are not described here.

### (a) Formation of Liquid Crystal Layer

First, 4′-hydroxychalcone was added as the polarized-light-absorbing compound 8 to 5CB, a liquid crystal material having a positive anisotropy of dielectric constant, to 3 wt % of the whole mixture. The temperature was then raised to 50° C. to dissolve the 4′-hydroxychalcone completely in the liquid crystal material. The amount of 4′-hydroxychalcone added is preferably in the range of 0.1 wt % to 10 wt % of the whole mixture with the liquid crystal material. If the amount of 4′-hydroxychalcone added is less than 0.1 wt %, the very low concentration may not enable formation of the later-described alignment control layer in the entire interface between the liquid crystal layer and each substrate, failing to control the alignment of liquid crystal molecules sufficiently. If the amount of 4′-hydroxychalcone added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes and a common electrode in the same layer and the upper substrate 3 including no electrode were prepared. Neither the lower substrate 2 nor the upper substrate 3 includes a conventional alignment film.

Then, after the sealing material 6 was applied to the lower substrate 2, the liquid crystal material to which 4′-hydroxychalcone was added as described above was dropwise added thereto at 50° C. The lower substrate 2 and the upper substrate 3 were then bonded to each other with the sealing material 6 in between as illustrated in the view (a) of FIG. 2, so that the liquid crystal layer 5 was formed.

### (b) Phase Separation of Polarized-Light-Absorbing Compound

The temperature of the liquid crystal cell produced in the step (a) was dropped to 25° C. such that the interaction (e.g. hydrogen bond) between the substrate surface and the hydroxyl groups in 4′-hydroxychalcone was stabilized and thereby phase separation of 4′-hydroxychalcone from the liquid crystal layer 5 occurred. As a result, as illustrated in the view (b) of FIG. 2, the layer 9a was formed between the lower substrate 2 and the liquid crystal layer 5 while the layer 9b was formed between the upper substrate 3 and the liquid crystal layer 5.

### (c) Formation of Alignment Control Layer

As illustrated in the view (c) of FIG. 2, the temperature of the liquid crystal cell after the step (b) was raised to 36° C., and the liquid crystal cell was irradiated with the linearly polarized ultraviolet light 10 from the normal direction thereof. The dose of the polarized ultraviolet light 10 was 3 J/cm² at a wavelength of 365 nm. As a result, chalcone groups in the 4′-hydroxychalcone constituting the layers 9a and 9b absorbed the linearly polarized ultraviolet light to cause a photoreaction such as a crosslinking reaction, whereby the alignment control layers 4a and 4b achieving a horizontal alignment mode as illustrated in the view (d) of FIG. 2 were formed.

### (d) Completion of Liquid Crystal Display Device

The temperature of the liquid crystal cell after the step (c) was dropped to the room temperature, and components such as polarizing plates and a backlight were suitably disposed. As a result, a horizontal electric field liquid crystal display device (liquid crystal display device of Example 4) as illustrated in the view (d) of FIG. 2 was completed which aligns the liquid crystal molecules 7 in a direction substantially parallel to the main surfaces of the lower substrate 2 and the upper substrate 3 with no voltage applied. The width of the completed sealing material 6 was 0.5 mm.

Example 4 therefore enables production of an IPS mode (horizontal alignment mode) liquid crystal display device even in the case of using another low molecular weight polarized-light-absorbing compound containing chalcone groups which is different from the polarized-light-absorbing compound in Example 3. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 4 was measured to be 0.5° or smaller from the main surfaces of the lower substrate 2 and the upper substrate 3. The pre-tilt angle was measured by the same method as in Example 1.

The transmitted light intensity of the liquid crystal display device produced in Example 4 was evaluated for the following cases (A) and (B). The transmitted light intensity was measured by the same method as in Example 1.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device transmitted the light emitted from the backlight with no voltage applied, providing a light transmissive state.

The ratio of the transmitted light intensity in the above light transmissive state in the above case (B) to the transmitted light intensity in the black state in the above case (A) (transmitted light intensity in light transmissive state/transmitted light intensity in black state) was about 55.

The above evaluation shows that the liquid crystal display device of Example 4 was in the IPS mode.

### Example 5

Example 5 is a case of using low molecular weight 4-hydroxyazobenzene as the polarized-light-absorbing compound to achieve a vertical alignment mode.

A liquid crystal display device of Example 5 is the same as the liquid crystal display device of Example 1 except that the alignment control layers 4a and 4b were formed through phase separation of 4-hydroxyazobenzene (polarized-light-absorbing compound), represented by the following chemical formula (5) and added to the liquid crystal layer 5, from the liquid crystal layer 5. The schematic cross-sectional view of the device is the same as illustrated in FIG. 1. In this case, the alignment control layers 4a and 4b can achieve a vertical alignment mode.

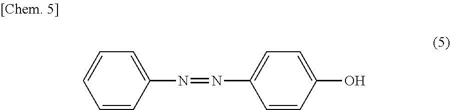 [SMILES: Oc1ccc(N=Nc2ccccc2)cc1]

As described above, the liquid crystal display device of Example 5 is a transverse bend alignment (TBA) mode (vertical alignment mode) liquid crystal display device. The liquid crystal display device of Example 5 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

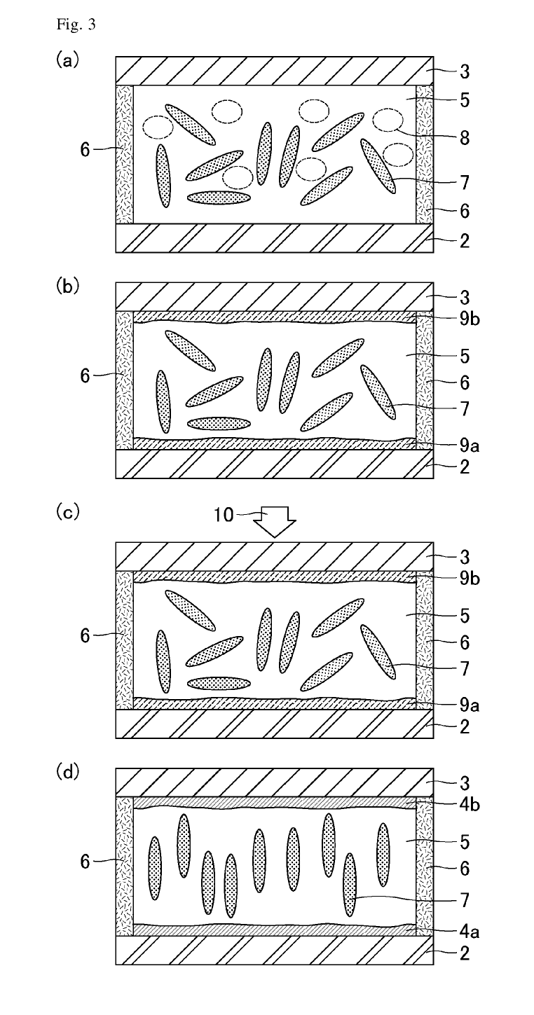

Next, the method for producing a liquid crystal display device of Example 5 is described with reference to FIG. 3. FIG. 3 includes schematic cross-sectional views illustrating a production flow for a liquid crystal display device of Example 5 (steps a to d). The method for producing a liquid crystal display device of Example 5 is the same as the method for producing a liquid crystal display device of Example 1, except that 4-hydroxyazobenzene was used in place of polyvinyl cinnamate as the polarized-light-absorbing compound 8. Hence, the same points are not described here.

### (a) Formation of Liquid Crystal Layer

First, 4-hydroxyazobenzene was added as the polarized-light-absorbing compound 8 to 5CB, a liquid crystal material having a positive anisotropy of dielectric constant, to 3 wt % of the whole mixture. The temperature was then raised to 50° C. to dissolve the 4-hydroxyazobenzene completely in the liquid crystal material. The amount of 4-hydroxyazobenzene added is preferably in the range of 0.1 wt % to 10 wt % of the whole mixture with the liquid crystal material. If the amount of 4-hydroxyazobenzene added is less than 0.1 wt %, the very low concentration may not enable formation of the later-described alignment control layer in the entire interface between the liquid crystal layer and each substrate, failing to control the alignment of liquid crystal molecules sufficiently. If the amount of 4-hydroxyazobenzene added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes and a common electrode (not illustrated) in the same layer and the upper substrate 3 including no electrode were prepared. Neither the lower substrate 2 nor the upper substrate 3 includes a conventional alignment film.

Then, after the sealing material 6 was applied to the lower substrate 2, the liquid crystal material to which 4-hydroxyazobenzene was added as described above was dropwise added thereto at 50° C. The lower substrate 2 and the upper substrate 3 were then bonded to each other with the sealing material 6 in between as illustrated in the view (a) of FIG. 3, so that the liquid crystal layer 5 was formed.

### (b) Phase Separation of Polarized-Light-Absorbing Compound

The temperature of the liquid crystal cell produced in the step (a) was dropped to 25° C. such that the interaction (e.g. hydrogen bond) between the substrate surface and the hydroxyl groups in 4-hydroxyazobenzene was stabilized and thereby phase separation of 4-hydroxyazobenzene from the liquid crystal layer 5 occurred. As a result, as illustrated in the view (b) of FIG. 3, the layer 9a is formed between the lower substrate 2 and the liquid crystal layer 5 while the layer 9b was formed between the upper substrate 3 and the liquid crystal layer 5.

### (c) Formation of Alignment Control Layer

As illustrated in the view (c) of FIG. 3, the temperature of the liquid crystal cell after the step (b) was raised to 36° C., and the liquid crystal cell was irradiated with the linearly polarized ultraviolet light 10 from the normal direction thereof. The dose of the polarized ultraviolet light 10 was 3 J/cm² at a wavelength of 365 nm. As a result, azobenzene groups in the 4-hydroxyazobenzene constituting the layers 9a and 9b absorbed the linearly polarized ultraviolet light to cause an isomerization reaction, whereby the alignment control layers 4a and 4b achieving a vertical alignment mode as illustrated in the view (d) of FIG. 3 were formed.

### (d) Completion of Liquid Crystal Display Device

The temperature of the liquid crystal cell after the step (c) was dropped to the room temperature, and components such as polarizing plates and a backlight were suitably disposed. As a result, a horizontal electric field liquid crystal display device (liquid crystal display device of Example 5) as illustrated in the view (d) of FIG. 3 was completed which aligns the liquid crystal molecules 7 in a direction substantially perpendicular to the main surfaces of the lower substrate 2 and the upper substrate 3 with no voltage applied. The width of the completed sealing material 6 was 0.5 mm.

Example 5 therefore enables production of a TBA mode (vertical alignment mode) liquid crystal display device. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 5 was measured to be 90° from the main surfaces of the lower substrate 2 and the upper substrate 3. The pre-tilt angle was measured by the same method as in Example 1.

The transmitted light intensity of the liquid crystal display device produced in Example 5 was evaluated for the following cases (A) and (B). The transmitted light intensity was measured by the same method as in Example 1.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device did not transmit the light emitted from the backlight with no voltage applied, providing a black state.

The ratio of the transmitted light intensity in the above case (B) to the transmitted light intensity in the above case (A) (transmitted light intensity in the case (B)/transmitted light intensity in the case (A)) was about 1.00, which indicates perfect vertical alignment.

The above evaluation shows that the liquid crystal display device of Example 5 was in the TBA mode.

### Example 6

Example 6 is a case of using 4(4-butylphenylazo)phenol as the polarized-light-absorbing compound to achieve a vertical alignment mode.

A liquid crystal display device of Example 6 is the same as the liquid crystal display device of Example 1 except that the alignment control layers 4a and 4b were formed through phase separation of 4(4-butylphenylazo)phenol (polarized-light-absorbing compound), represented by the following chemical formula (6) and added to the liquid crystal layer 5, from the liquid crystal layer 5, and that the electrode arrangements in the lower substrate 2 and the upper substrate 3 were different. The schematic cross-sectional view of the device is the same as illustrated in FIG. 1. In this case, the alignment control layers 4a and 4b can achieve a vertical alignment mode. The lower substrate 2 includes a glass substrate as the supporting substrate and components such as thin-film transistor elements suitably disposed on the glass substrate, and also includes pixel electrodes (not illustrated) on the entire surface of the substrate surface layer. The upper substrate 3 includes a glass substrate as the supporting substrate and components such as color filter layers suitably disposed on the glass substrate, and also includes a common electrode (not illustrated) on the entire surface of the substrate surface layer. The sealing material 6 is in direct contact with the lower substrate 2 and in direct contact with the upper substrate 3.

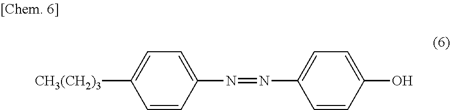

As described above, the liquid crystal display device of Example 6 is a VA mode (vertical alignment mode) liquid crystal display device. The liquid crystal display device of Example 6 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

Next, the method for producing a liquid crystal display device of Example 6 is described. The method for producing a liquid crystal display device of Example 6 is the same as the method for producing a liquid crystal display device of Example 5, except that 4(4-butylphenylazo)phenol was used in place of 4-hydroxyazobenzene as the polarized-light-absorbing compound 8, substrates each provided with electrode(s) on the entire surface of the surface layer were used as the lower substrate 2 and the upper substrate 3, and a liquid crystal material having a negative anisotropy of dielectric constant was used as the liquid crystal material. The schematic cross-sectional views illustrating the production flow are the same as illustrated in FIG. 3. Hence, the same points are not described here.

### (a) Formation of Liquid Crystal Layer

First, 4(4-butylphenylazo)phenol was added as the polarized-light-absorbing compound 8 to a liquid crystal material (model: MLC-6608) from Merck KGaA, a liquid crystal material having a negative anisotropy of dielectric constant, to 3 wt % of the whole mixture. The 4(4-butylphenylazo)phenol was dissolved in the liquid crystal material at room temperature. 4(4-Butylphenylazo)phenol, containing butyl groups, has high liquid crystal solubility and dissolves by several wt % in liquid crystal at room temperature. T_{N-I} of MLC-6608, a liquid crystal material, is 90° C. The amount of 4(4-butylphenylazo)phenol added is preferably in the range of 0.1 wt % to 10 wt % of the whole mixture with the liquid crystal material. If the amount of 4(4-butylphenylazo)phenol added is less than 0.1 wt %, the very low concentration may not enable formation of the later-described alignment control layer in the entire interface between the liquid crystal layer and each substrate, failing to control the alignment of liquid crystal molecules sufficiently. If the amount of 4(4-butylphenylazo)phenol added is more than 10 wt %, the very high concentration is highly likely to cause the polarized-light-absorbing compound to remain in the liquid crystal layer after the subsequent steps, which may affect the properties such as reliability.

Next, the lower substrate 2 including pixel electrodes (not illustrated) on the entire surface of the substrate surface layer and the upper substrate 3 including a common electrode (not illustrated) on the entire surface of the substrate surface layer were prepared. Neither the lower substrate 2 nor the upper substrate 3 includes a conventional alignment film.

Then, after the sealing material 6 was applied to the lower substrate 2, the liquid crystal material to which 4(4-butylphenylazo)phenol was added as described above was dropwise added thereto at 25° C. The lower substrate 2 and the upper substrate 3 were then bonded to each other with the sealing material 6 in between as illustrated in the view (a) of FIG. 3, so that the liquid crystal layer 5 was formed.

### (b) Phase Separation of Polarized-Light-Absorbing Compound

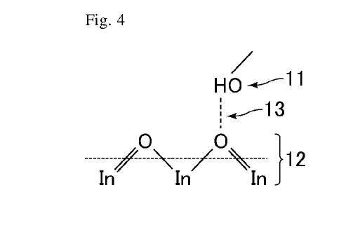

In the liquid crystal cell produced in the step (a), phase separation of 4(4-butylphenylazo)phenol from the liquid crystal layer 5 was allowed to occur. This process can be described with reference to FIG. 4. FIG. 4 is a conceptual view for describing phase separation of a polarized-light-absorbing compound in Example 6. As illustrated in FIG. 4, a hydroxy group 11 in 4(4-butylphenylazo)phenol is adsorbed by a hydrogen bond 13 on an indium oxide surface 12 of ITO which is a material of the pixel electrodes constituting the surface layer of the lower substrate 2 and the common electrode constituting the surface layer of the upper substrate 3, so that phase separation of 4(4-butylphenylazo)phenol from the liquid crystal layer 5 occurs. As a result, as illustrated in the view (b) of FIG. 3, the layer 9a is formed between the lower substrate 2 and the liquid crystal layer 5 while the layer 9b was formed between the upper substrate 3 and the liquid crystal layer 5.

In the case of causing phase separation of the polarized-light-absorbing compound from the liquid crystal layer through such an adsorption process, the material constituting the surface layer of the substrates may be any inorganic compound. The inorganic compound can be a metal oxide (e.g. ITO), an inorganic oxide (e.g. silicon oxide (SiO), glass), or an inorganic nitride (e.g. silicon nitride (SiN)). Also, a polarized-light-absorbing compound containing amino groups can cause phase separation of the polarized-light-absorbing compound from the liquid crystal layer through such an absorption process.

### (c) Formation of Alignment Control Layer

As illustrated in the view (c) of FIG. 3, the temperature of the liquid crystal cell after the step (b) was raised to 91° C., and the liquid crystal cell was irradiated with the linearly polarized ultraviolet light 10 from the normal direction thereof. The dose of the polarized ultraviolet light 10 was 3 J/cm² at a wavelength of 365 nm. As a result, azobenzene groups in the 4(4-butylphenylazo)phenol constituting the layers 9a and 9b absorbed the linearly polarized ultraviolet light to cause an isomerization reaction, whereby the alignment control layers 4a and 4b achieving a vertical alignment mode as illustrated in the view (d) of FIG. 3 were formed.

### (d) Completion of Liquid Crystal Display Device

The temperature of the liquid crystal cell after the step (c) was dropped to the room temperature, and components such as polarizing plates and a backlight were suitably disposed. As a result, a vertical electric field liquid crystal display device (liquid crystal display device of Example 6) as illustrated in the view (d) of FIG. 3 was completed which aligns the liquid crystal molecules 7 in a direction substantially perpendicular to the main surfaces of the lower substrate 2 and the upper substrate 3 with no voltage applied. The width of the completed sealing material 6 was 0.5 mm.

Example 6 therefore enables production of a VA mode (vertical alignment mode) liquid crystal display device even in the case of using a polarized-light-absorbing compound that dissolves in liquid crystal at room temperature. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 6 was measured to be 90° from the main surfaces of the lower substrate 2 and the upper substrate 3. The pre-tilt angle was measured by the same method as in Example 1.

The transmitted light intensity of the liquid crystal display device produced in Example 6 was evaluated for the following cases (A) and (B). The transmitted light intensity was measured by the same method as in Example 1.

(A) The case where when one of absorption axes of a pair of absorptive polarizing plates disposed in the crossed Nicols and the radiation axis of the linearly polarized ultraviolet light 10 radiated in the above step (c) form an angle of 0° and the other of the absorption axes and the radiation axis of the linearly polarized ultraviolet light 10 radiated in the above step (c) form an angle of 90°, the liquid crystal display device did not transmit the light emitted from the backlight with no voltage applied, providing a black state.

(B) The case where when each of the absorption axes of a pair of absorptive polarizing plates disposed in the crossed Nicols and the radiation axis of the linearly polarized ultraviolet light 10 radiated in the above step (c) form an angle of 45°, the liquid crystal display device did not transmit the light emitted from the backlight with no voltage applied, providing a black state.

The ratio of the transmitted light intensity in the above case (B) to the transmitted light intensity in the above case (A) (transmitted light intensity in the case (B)/transmitted light intensity in the case (A)) was about 1.00, which indicates perfect vertical alignment.

The above evaluation shows that the liquid crystal display device of Example 6 was in the VA mode. Although the configuration for the VA mode was achieved in Example 6, the configuration for the multi-domain vertical alignment (MVA) mode which is also a vertical alignment mode driven by a vertical electric field and the configuration for the vertical ECB mode can also be achieved. For example, in the case of achieving the MVA mode, a substrate including ribs as alignment control structures on pixel electrodes and a common electrode may be used as the lower substrate 2 and as the upper substrate 3.

### Example 7

Example 7 is a case of using a low molecular weight compound represented by the following chemical formula (7) as the polarized-light-absorbing compound to achieve a vertical alignment mode.

A liquid crystal display device of Example 7 is the same as the liquid crystal display device of Example 6 except that the alignment control layers 4a and 4b were formed through phase separation of the polarized-light-absorbing compound, represented by the following chemical formula (7) and added to the liquid crystal layer 5, from the liquid crystal layer 5. The schematic cross-sectional view of the device is the same as illustrated in FIG. 1. In this case, the alignment control layers 4a and 4b can achieve a vertical alignment mode.

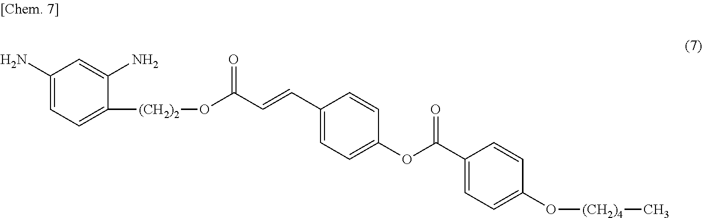

As described above, the liquid crystal display device of Example 7 is a VA, vertical ECB, or vertical twisted nematic (TN) mode (vertical alignment mode) liquid crystal display device. The liquid crystal display device of Example 7 does not include a portion where an alignment film and a sealing material are in contact with each other, differently from the conventional liquid crystal display devices. This configuration can avoid the issue of peeling in the interface between an alignment film and a sealing material, thereby achieving a liquid crystal display device that is less likely to cause peeling even with a narrow frame.

Next, the method for producing a liquid crystal display device of Example 7 is described with reference to FIG. 5. FIG. 5 includes schematic cross-sectional views illustrating a production flow for a liquid crystal display device of Example 7 (steps a to d). The method for producing a liquid crystal display device of Example 7 is the same as the method for producing a liquid crystal display device of Example 6, except that the compound represented by the above chemical formula (7) was used in place of 4-hydroxyazobenzene as the polarized-light-absorbing compound 8 and that the linearly polarized ultraviolet light was radiated from a different direction. Hence, the same points are not described here.

### (a) Formation of Liquid Crystal Layer

First, the compound represented by the above chemical formula (7) was added as the polarized-light-absorbing compound 8 to MLC-6608, a liquid crystal material having a negative anisotropy of dielectric constant, to 3 wt % of the whole mixture. The compound represented by the above chemical formula (7) was dissolved in the liquid crystal material at room temperature. The compound represented by the above chemical formula (7) is dissolvable up to 5 wt % in a liquid crystal material having a negative anisotropy of dielectric constant at room temperature. The amount of the compound represented by the above chemical formula (7) added is preferably in the range of 0.1 wt % to 5 wt % of the whole mixture with the liquid crystal material. If the amount of the compound represented by the above chemical formula (7) added is less than 0.1 wt %, the very low concentration may not enable formation of the later-described alignment control layer in the entire interface between the liquid crystal layer and each substrate, failing to control the alignment of liquid crystal molecules sufficiently. If the amount of the compound represented by the above chemical formula (7) added is more than 5 wt %, the compound does not fully dissolve in a liquid crystal material having negative anisotropy of dielectric constant at room temperature.

Next, the lower substrate 2 including pixel electrodes on the entire surface of the substrate surface layer and the upper substrate 3 including a common electrode on the entire surface of the substrate surface layer were prepared. Neither the lower substrate 2 nor the upper substrate 3 includes a conventional alignment film.

Then, after the sealing material 6 was applied to the lower substrate 2, the liquid crystal material to which the compound represented by the above chemical formula (7) was added as described above was dropwise added thereto at 25° C. The lower substrate 2 and the upper substrate 3 were then bonded to each other with the sealing material 6 in between as illustrated in the view (a) of FIG. 5, so that the liquid crystal layer 5 was formed.

### (b) Phase Separation of Polarized-Light-Absorbing Compound

In the liquid crystal cell produced in the step (a), phase separation of the compound represented by the above chemical formula (7) from the liquid crystal layer 5 was allowed to occur. The phase separation of the compound represented by the above chemical formula (7) from the liquid crystal layer 5 occurs because, as already described in Example 6, an amino group in the compound represented by the above chemical formula (7) is adsorbed by a hydrogen bond on the indium oxide surface of ITO which is a material of the pixel electrodes constituting the surface layer of the lower substrate 2 and the common electrode constituting the surface layer of the upper substrate 3. As a result, as illustrated in the view (b) of FIG. 5, the layer 9a is formed between the lower substrate 2 and the liquid crystal layer 5 while the layer 9b was formed between the upper substrate 3 and the liquid crystal layer 5.

### (c) Formation of Alignment Control Layer

As illustrated in the view (c) of FIG. 5, the temperature of the liquid crystal cell after the step (b) was raised to 91° C., and the liquid crystal cell was irradiated with the linearly polarized ultraviolet light 10 from a direction at an angle of 40° from the normal direction thereof. The dose of the polarized ultraviolet light 10 was 3 J/cm² at a wavelength of 330 nm. As a result, cinnamate groups in the compound represented by the above chemical formula (7) constituting the layers 9a and 9b absorbed the linearly polarized ultraviolet light to cause a photoreaction such as a crosslinking reaction, whereby the alignment control layers 4a and 4b achieving a vertical alignment mode as illustrated in the view (d) of FIG. 5 were formed.

### (d) Completion of Liquid Crystal Display Device

The temperature of the liquid crystal cell after the step (c) was dropped to the room temperature, and components such as polarizing plates and a backlight were suitably disposed. As a result, a vertical electric field liquid crystal display device (liquid crystal display device of Example 7) as illustrated in the view (d) of FIG. 5 was completed which aligns the liquid crystal molecules 7 in a direction substantially perpendicular to the main surfaces of the lower substrate 2 and the upper substrate 3 with no voltage applied. The width of the completed sealing material 6 was 0.5 mm.

Example 7 therefore enabled production of a VA, vertical ECB, or vertical TN mode (vertical alignment mode) liquid crystal display device even in the case of using a polarized-light-absorbing compound that dissolves in liquid crystal at room temperature and is different from the compound in Example 6. Also, since the sealing material 6 was in direct contact with the lower substrate 2 and the upper substrate 3 without conventional alignment films disposed in between, a liquid crystal display device can be produced which is less likely to cause peeling even with a narrow frame.

### [Evaluation of Liquid Crystal Display Device]

The pre-tilt angle of the liquid crystal molecules 7 in the liquid crystal display device produced in Example 7 was measured to be 89.3° from the main surfaces of the lower substrate 2 and the upper substrate 3. The pre-tilt angle was measured by the same method as in Example 1.

As described above, irradiation of the liquid crystal cell with the linearly polarized ultraviolet light 10 from a direction at an angle from the normal direction enabled alignment control of the liquid crystal molecules 7 at a slight angle from the exact vertical direction. In Example 7, the liquid crystal cell was irradiated with the linearly polarized ultraviolet light 10 without using a mask. In a modified example of Example 7, when the liquid crystal cell is irradiated using a mask, at least two regions (domains) with different alignment directions of the liquid crystal molecules can be formed in one pixel region (e.g. 4-domain alignment), so that a liquid crystal display device with excellent viewing angle characteristics can be achieved. For example, suitably changing the configurations of the lower substrate 2 and the upper substrate 3 enables a mode such as the 4-domain vertical ECB mode and the 4-domain vertical TN mode.

### [Evaluation of Adhesion Strength]

The following three samples were produced and subjected to evaluation of the adhesion strength in the interface with a sealing material. Table 1 shows the results.

### (First Sample: For Evaluation)

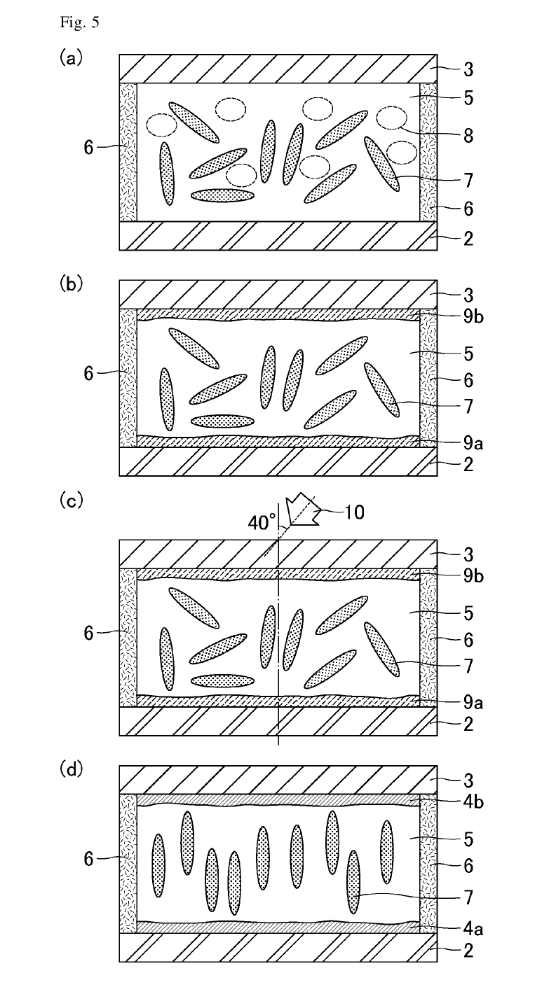

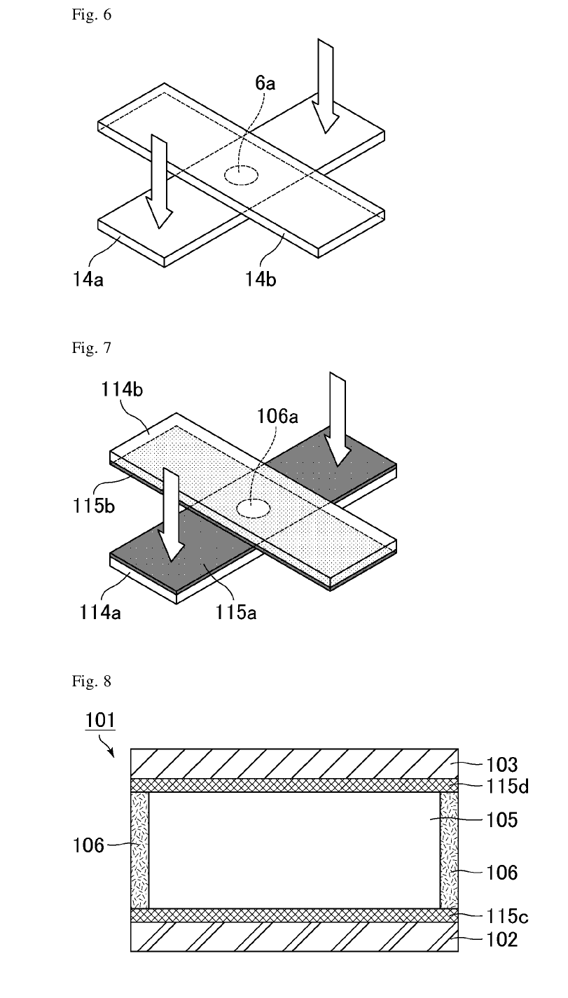

FIG. 6 is a schematic perspective view illustrating a first sample. Glass substrates 14a and 14b without conventional alignment films were prepared as evaluation substrates. To one of the glass substrates 14a and 14b was applied a sealing material 6a with a diameter of 2 mm. The glass substrates 14a and 14b were then orthogonally bonded to each other with the sealing material 6a. The sealing material 6a, after being irradiated with ultraviolet light, was cured by heat, whereby a sample as illustrated in FIG. 6 was produced. Hence, in the first sample, the sealing material 6a is in direct contact with the glass substrates 14a and 14b. The glass substrates 14a and 14b used were each made of non-alkaline glass from Corning Incorporated. The size of each of the glass substrates 14a and 14b was 20 mm×50 mm with a thickness of 0.7 mm. The sealing material 6a used was a sealing material (model: Photolec S) from Sekisui Chemical Co., Ltd.

### (Second Sample: For Comparison)

FIG. 7 is a schematic perspective view illustrating a second sample. Glass substrates 114a and 114b on which conventional horizontal alignment polyimide alignment films 115a and 115b were respectively formed were prepared as evaluation substrates. To the alignment film 115a was applied a sealing material 106a with a diameter of 2 mm. The glass substrates 114a and 114b were then orthogonally bonded to each other with the sealing material 106a. Here, the glass substrates were bonded with the surfaces of the alignment films 115a and 115b facing each other. The sealing material 106a, after being irradiated with ultraviolet light, was cured by heat, whereby a sample as illustrated in FIG. 7 was produced. Hence, in the second sample, the sealing material 106a is in direct contact with the alignment films 115a and 115b. The glass substrates 114a and 114b used were each made of non-alkaline glass from Corning Incorporated. The size of each of the glass substrates 114a and 114b was 20 mm×50 mm with a thickness of 0.7 mm. The sealing material 106a used was a sealing material (model: Photolec S) from Sekisui Chemical Co., Ltd.

### (Third Sample: For Comparison)

A third sample was the same as the second sample except that conventional vertical alignment polyimide alignment films were used as the alignment films 115a and 115b. The schematic perspective view of the sample is the same as illustrated in FIG. 7. Thereby, in the third sample, the sealing material 106a is in direct contact with the alignment films 115a and 115b.

### (Evaluation Method)

Each sample was subjected to a test in which the sample was left to stand for 100 hours in an environment with a temperature of 55° C. and a humidity of 90%. The adhesion strength of the sample was measured before and after the test. Each adhesion strength value obtained was a value measured by causing peeling in the interface between the evaluation substrate and the sealing material with a load applied in the direction of arrows illustrated in FIG. 6 and FIG. 7.

TABLE 1

Adhesion strength (kgf/mm)

| | Before test | After test |
|---|---|---|
| First sample (for evaluation) | 2.8 | 2.8 |
| Second sample (for comparison) | 2.6 | 1.5 |
| Third sample (for comparison) | 1.1 | 0.2 or lower |

As shown in Table 1, the first sample retained higher adhesion strength (2.8 kgf/mm) than the second and third samples without a decrease in the adhesion strength between before and after the test. The second sample had an adhesion strength before the test of 2.6 kgf/mm, which was a value close to the value of the first sample, but showed a drop in the adhesion strength to 1.5 kgf/mm after the test. Also, the third sample had an adhesion strength before the test of 1.1 kgf/mm which was lower than the values of the first and second samples, and showed a drop in the adhesion strength to 0.2 kgf/mm or lower after the test. Accordingly, a configuration as in the present invention in which a conventional alignment film was not included and an alignment film and a sealing material were not in contact with each other was evaluated as being able to give a liquid crystal display device that is capable of retaining high adhesion strength and less likely to cause peeling even with a narrow frame. In the present evaluation, the first sample had a configuration in which the sealing material was in direct contact with the glass substrates, but the same effect can be achieved even with a configuration in which the sealing material is in direct contact with components (e.g., electrodes, insulating films) other than the alignment films formed on the glass substrates.

### [Additional Remarks]

Hereinafter, preferred embodiments of the liquid crystal display device of the present invention are described. These embodiments may be appropriately combined within the spirit of the present invention.

In the present invention, the sealing material is in direct contact with the pair of substrates without conventional alignment films in between. Neither of the substrates in pairs includes a conventional alignment film. Examples of the components constituting the surface layer of each of the substrates and in direct contact with the sealing material include supporting substrates (e.g., glass substrates), electrodes, and insulating films. From the viewpoint of increasing the adhesion strength, a configuration is preferred in which an inorganic compound and a sealing material are in direct contact with each other.

The polarized-light-absorbing compound may contain in a molecule at least one polarized-light-absorbing functional group selected from the group consisting of cinnamate groups, coumarin groups, azobenzene groups, stilbene groups, chalcone groups, and tolane groups. The polarized-light-absorbing functional group may be a cinnamate, azobenzene, or chalcone group. Thereby, the polarized-light-absorbing compound can be effectively utilized, owing to the effect that the polarized-light-absorbing functional groups, when irradiated with polarized light, absorb the polarized light to cause a photoreaction such as a crosslinking reaction, enabling control of the alignment of liquid crystal molecules.

The polarized-light-absorbing functional group may contain the at least one of a phenylene group and a phenyl group and the at least one of a carbonyl group and an azo group.

The alignment control layer may be formed by dropping the temperature of the liquid crystal layer from T_{N-I} or higher to lower than T_{N-I} to cause phase separation of the polarized-light-absorbing compound from the liquid crystal layer, the T_{N-I} representing the phase transition temperature of a liquid crystal material contained in the liquid crystal layer between a nematic phase and an isotropic phase. Thereby, the alignment control layers suitably obtained can be effectively used, owing to the effect that the polarized-light-absorbing compound dissolves in the liquid crystal material at a temperature equal to or higher than T_{N-I} and goes through phase separation from the liquid crystal layer at a temperature lower than T_{N-I}.

The alignment control layer may be formed by adsorbing the polarized-light-absorbing compound on an inorganic compound constituting the surface layer of each of the substrates in pairs, thereby causing phase separation of the polarized-light-absorbing compound from the liquid crystal layer. Thereby, the alignment control layers suitably obtained can be effectively used, owing to the effect that the polarized-light-absorbing compound is adsorbed on the inorganic compound.

The polarized-light-absorbing compound may be adsorbed on the inorganic compound by a hydrogen bond. The polarized-light-absorbing compound may contain a carboxyl, hydroxyl, or amino group. Thereby, the polarized-light-absorbing compound can be suitably adsorbed on the inorganic compound. The inorganic compound is preferably ITO or glass.

The alignment control layers may be designed to align liquid crystal molecules in a direction substantially parallel to main surfaces of the substrates with no voltage applied. Thereby, a horizontal alignment mode liquid crystal display device can be achieved.

The alignment control layers may be designed to align liquid crystal molecules in a direction substantially perpendicular to main surfaces of the substrates with no voltage applied. Thereby, a vertical alignment mode liquid crystal display device can be achieved.

The liquid crystal material contained in the liquid crystal layer may have a positive anisotropy of dielectric constant. Thereby, the long axis of each liquid crystal molecule is aligned along the line of electric force with voltage applied. This facilitates alignment control and can achieve even higher response speed.

The liquid crystal material contained in the liquid crystal layer may have a negative anisotropy of dielectric constant. Thereby, the transmittance can be further increased.

The liquid crystal display mode of the liquid crystal display device may be the IPS mode, FFS mode, ECB mode, vertical ECB mode, 4-domain vertical ECB mode, TBA mode, VA mode, MVA mode, or 4-domain vertical TN mode.

Hereinafter, preferred embodiments of the method for producing a liquid crystal display device according to the present invention will be described. These embodiments may be appropriately combined within the spirit of the present invention. Here, the same points as in the description for the preferred embodiments of the liquid crystal display device of the present invention may not be described.

In the present invention, the suitable polarized light to be radiated in the step (3) is polarized ultraviolet light, with linearly polarized ultraviolet light being particularly suitable. Also, the radiation conditions for the polarized light can be set to those suitable for the composition of the polarized-light-absorbing compound.

The step (3) may be performed by irradiating the layers with polarized light with the temperature of the liquid crystal layer being set in the range of T_{N-I} to T_{N-I}+5° C.

The step (1) may be performed with the temperature of the liquid crystal layer being set to T_{N-I} or higher, and the step (2) may be performed with the temperature of the liquid crystal layer being dropped from T_{N-I} or higher to lower than T_{N-I}. Thereby, the alignment control layers can be suitably obtained owing to the effect that the polarized-light-absorbing compound dissolves in the liquid crystal material at a temperature of T_{N-I} or higher and goes through phase separation from the liquid crystal layer at a temperature lower than T_{N-I}.

The step (2) may be performed by adsorbing the polarized-light-absorbing compound on an inorganic compound constituting a surface layer of each of the substrates. Thereby, the alignment control layers can be suitably obtained owing to the effect that the polarized-light-absorbing compound is adsorbed on the inorganic compound.

The step (2) may be performed by adsorbing the polarized-light-absorbing compound on the inorganic compound by a hydrogen bond. The polarized-light-absorbing compound may contain a carboxyl, hydroxyl, or amino group. Thereby, the polarized-light-absorbing compound can be suitably adsorbed on the inorganic compound. The inorganic compound is preferably ITO or glass.

### REFERENCE SIGNS LIST

1, 101: liquid crystal display device
2, 102: lower substrate
3, 103: upper substrate
4a, 4b: alignment control layer
5, 105: liquid crystal layer
6, 6a, 106, 106a: sealing material
7: liquid crystal molecule
8: polarized-light-absorbing compound
9a, 9b: layer
10: linearly polarized ultraviolet light
11: hydroxyl group
12: indium oxide surface
13: hydrogen bond
14a, 14b, 114a, 114b: glass substrate
115a, 115b, 115c, 115d: alignment film

1. A liquid crystal display device comprising:
a pair of substrates disposed to face each other;
a liquid crystal layer and a sealing material disposed between the substrates; and
an alignment control layer that is designed to control the alignment of liquid crystal molecules and is disposed between each of the substrates and the liquid crystal layer,
the substrates being in direct contact with the sealing material,
the alignment control layers each being made of a polarized-light-absorbing compound,
the polarized-light-absorbing compound containing in a molecule at least one of a phenylene group and a phenyl group and at least one of a carbonyl group and an azo group.

2. The liquid crystal display device according to claim 1,
wherein the polarized-light-absorbing compound contains in a molecule at least one polarized-light-absorbing functional group selected from the group consisting of cinnamate groups, coumarin groups, azobenzene groups, stilbene groups, chalcone groups, and tolane groups.

3. The liquid crystal display device according to claim 2,
wherein the polarized-light-absorbing functional group is a cinnamate, azobenzene, or chalcone group.

4. The liquid crystal display device according to claim 1,
wherein the polarized-light-absorbing compound contains a carboxyl, hydroxyl, or amino group.

5. The liquid crystal display device according to claim 1,
wherein the alignment control layers are designed to align liquid crystal molecules in a direction substantially parallel to main surfaces of the substrates with no voltage applied.

6. The liquid crystal display device according to claim 1,
wherein the alignment control layers are designed to align liquid crystal molecules in a direction substantially perpendicular to main surfaces of the substrates with no voltage applied.

7. A method for producing a liquid crystal display device, comprising the steps of:
(1) forming a liquid crystal layer containing a polarized-light-absorbing compound between substrates that are in pairs and are bonded to each other with a sealing material;
(2) causing phase separation of the polarized-light-absorbing compound from the liquid crystal layer to form a layer between each of the substrates and the liquid crystal layer; and
(3) irradiating the layers with polarized light with the temperature of the liquid crystal layer being set to T_{N-I} or higher to form alignment control layers designed to control the alignment of liquid crystal molecules, the T_{N-I} representing a phase transition temperature of a liquid crystal material contained in the liquid crystal layer between a nematic phase and an isotropic phase,
the polarized-light-absorbing compound containing in a molecule at least one of a phenylene group and a phenyl group and at least one of a carbonyl group and an azo group.

8. The method for producing a liquid crystal display device according to claim 7,
wherein the step (3) is performed by irradiating the layers with polarized light with the temperature of the liquid crystal layer being set in the range of T_{N-I} to T_{N-I}+5° C.

9. The method for producing a liquid crystal display device according to claim 7,
wherein the polarized-light-absorbing compound contains in a molecule at least one polarized-light-absorbing functional group selected from the group consisting of cinnamate groups, coumarin groups, azobenzene groups, stilbene groups, chalcone groups, and tolane groups.

10. The method for producing a liquid crystal display device according to claim 9,
wherein the polarized-light-absorbing functional group is a cinnamate, azobenzene, or chalcone group.

11. The method for producing a liquid crystal display device according to claim 7,
wherein the step (1) is performed with the temperature of the liquid crystal layer being set to T_{N-I} or higher, and
the step (2) is performed with the temperature of the liquid crystal layer being dropped from T_{N-I} or higher to lower than T_{N-I}.

12. The method for producing a liquid crystal display device according to claim 7,
wherein the step (2) is performed by adsorbing the polarized-light-absorbing compound on an inorganic compound constituting a surface layer of each of the substrates.

13. The method for producing a liquid crystal display device according to claim 12,
wherein the step (2) is performed by adsorbing the polarized-light-absorbing compound on the inorganic compound by a hydrogen bond.

14. The method for producing a liquid crystal display device according to claim 12,
wherein the polarized-light-absorbing compound contains a carboxyl, hydroxyl, or amino group.

15. The method for producing a liquid crystal display device according to claim 7,
wherein the alignment control layers are designed to align liquid crystal molecules in a direction substantially parallel to main surfaces of the substrates with no voltage applied.

16. The method for producing a liquid crystal display device according to claim 7,
wherein the alignment control layers are designed to align liquid crystal molecules in a direction substantially perpendicular to main surfaces of the substrates with no voltage applied.
